(19) United States
(12) Patent Application Publication
(10) Pub. No.: US 2006/0151368 A1
(43) Pub. Date: Jul. 13, 2006

(54) Particulate filter for oil

(75) Inventor: Gary Hunsinger, Rochester, NY (US)

Correspondence Address: HISCOCK & BARCLAY, LLP, 2000 HSBC PLAZA, ROCHESTER, NY, 14604-2404, US

(73) Assignee: Shawndra Products

(21) Appl. No.: 11/360,893

(22) Filed: Feb. 23, 2006

Related U.S. Application Data
(63) Continuation-in-part of application No. 10/411,487, filed on Apr. 10, 2003, now abandoned.

(51) Int. Cl. B01D 35/14

(52) U.S. Cl. 210/132; 210/314; 210/335; 210/435

(57) ABSTRACT

A multi-stage particulate filter, wherein the first stage of filtration comprises a coarse filter to remove the larger impurities. The second stage will remove the finer impurities from the liquid (oil) that have passed through the first stage (coarse filter). The first and second stage filter shall reside within a single housing. The housing will have both an inlet port for receiving the unfiltered fluid (oil) and an discharge port for passing the filtered fluid (oil) back into the system. The first stage, or coarse filter element has an opening adjacent the inlet, such that fluid entering through the inlet will first pass through the coarse filter element.

### CROSS-REFERENCE TO RELATED APPLICATION

This application claims priority to and is a continuation-in-part of U.S. application Ser. No. 10/411,487 filed Apr. 10, 2003.

### FIELD OF THE INVENTION

The present invention relates to particulate filters; more particularly, to a multistage particulate filter; and most particularly, to a multistage particulate filter with bypass capabilities.

### BACKGROUND

Gas turbines are a popular choice for power generation projects. Generally, gas turbines are combustion engines that produce work by burning fuel, such as methane, natural gas, and oil. Air is drawn into the turbine and subsequently pressurized in various stages. The pressurized air then enters the combustion chamber where it is mixed with the fuel and burned. Upon burning, the gasses within the combustion chamber rapidly expand, turning the turbine blades, thus generating power.

Advanced gas turbines, as used in power generation facilities, have high turbine-inlet temperatures and extremely heavy rotors, which make selection of oil, and maintaining of its cleanliness, vital in assuring long term reliability.

Additionally, low grade fuel and lubrication oil can be comprised of significant impurities, such as: sodium, potassium, calcium, vanadium and other metals. Using such low grade oil can often result in corrosion of turbine super alloys. This corrosion, along with increased turbine fouling, have a negative effect on the unit's efficiency and can lead to maintenance problems and down time. Prior to burning the fuel oil it is necessary to filter out as many of the above mentioned corrosive elements as possible.

Therefore, the removal of impurities is essential for both oil used for lubrication and fuel oil. Additionally, as lubrication oil continues to cycle through the system, it continues to pick up additional corrosives in the process. Therefore a good filtration system is also an essential element in the use of lubrication oil.

An adequate filtering system often provides for less down time and maintenance problems when operating machinery. Current filtering systems may provide coarse filter elements that filter out some of the larger impurities, but allow many of the smaller impurities to pass through and enter the system. Additionally, other filtering systems are known that provide fine filtering elements, however, these elements quickly become clogged from the passing of low grade fuel. Replacing these filters is burdensome, and often results in a great deal of maintenance and down time.

What is needed in the field is a fuel oil filtering system having a coarse filter for removing larger contaminants, as well as fine filters elements for removing smaller contaminants.

Additionally, what is needed in the field is a coarse filter element that allows the passage of a liquid to a finer filter element in the event the coarse element becomes clogged, without removing the coarse filter.

Furthermore, what is needed in the art is a reusable coarse filter element that is easily cleaned and replaced into the system.

Still furthermore, what is needed in the art is a third stage filter that will protect the above mentioned fine filter elements from element failure or back pulses in the system.

### BRIEF DESCRIPTION OF THE INVENTION

In view of the aforementioned conditions, it is a feature of the present invention to provide two stages of filtration to remove impurities from oil. The first stage of filtration comprises a coarse filter to remove the larger impurities. The second stage will remove the finer impurities from the liquid (oil) that have passed through the first stage (coarse filter). The first and second stage filter shall reside within a single housing. The housing will have both an inlet port for receiving the unfiltered fluid (oil) and an discharge port for passing the filtered fluid (oil) back into the system. The first stage, or coarse filter element has an opening adjacent the inlet, such that fluid entering through the inlet will first pass through the coarse filter element.

An additional aspect of the present invention is placing the coarse filter element an appropriate distance from the inlet such that the natural flow of the fluid from the inlet is into the coarse filters orifice, however, should the coarse filter become clogged or full with debris, fluid will bypass the first stage and directly feed the second stage filters. Thus, the coarse filter element allows continuous flow of liquid to the secondary filter element, while the liquid remains internal to the filter assembly at all times. Therefore, by-pass occurs automatically if the fine mesh becomes clogged. No additional by-pass elements are needed.

A further aspect of the present invention is that the first stage filter element be easily removable, cleaned and placed back into the system.

A still further aspect of the present invention is to provide a third stage filter for protecting the fine filter elements from element failure or back pulses in the system.

In a specific embodiment of the present invention, the aforedescribed filter is used to filter out contaminates from fuel oil or lubrication oil.

### BRIEF DESCRIPTION OF THE DRAWINGS

The invention as well as its features and advantages will become more apparent from the following description of a preferred embodiment of the invention and the accompanying drawings in which like numerals represent like parts.

FIG. 1 is a perspective view of the interior of a particular embodiment of a two stage particulate filter of the present invention.

FIG. 2 is a perspective view of the interior of a particular embodiment of a two stage particulate filter of the present invention with fine filters removed.

FIG. 3 is a top view of a partition plate and filter elements of one particular embodiment of the present invention.

FIG. 4 is a side view of the interior of a particular embodiment of a three stage particulate filter of the present invention.

### DETAILED DESCRIPTION

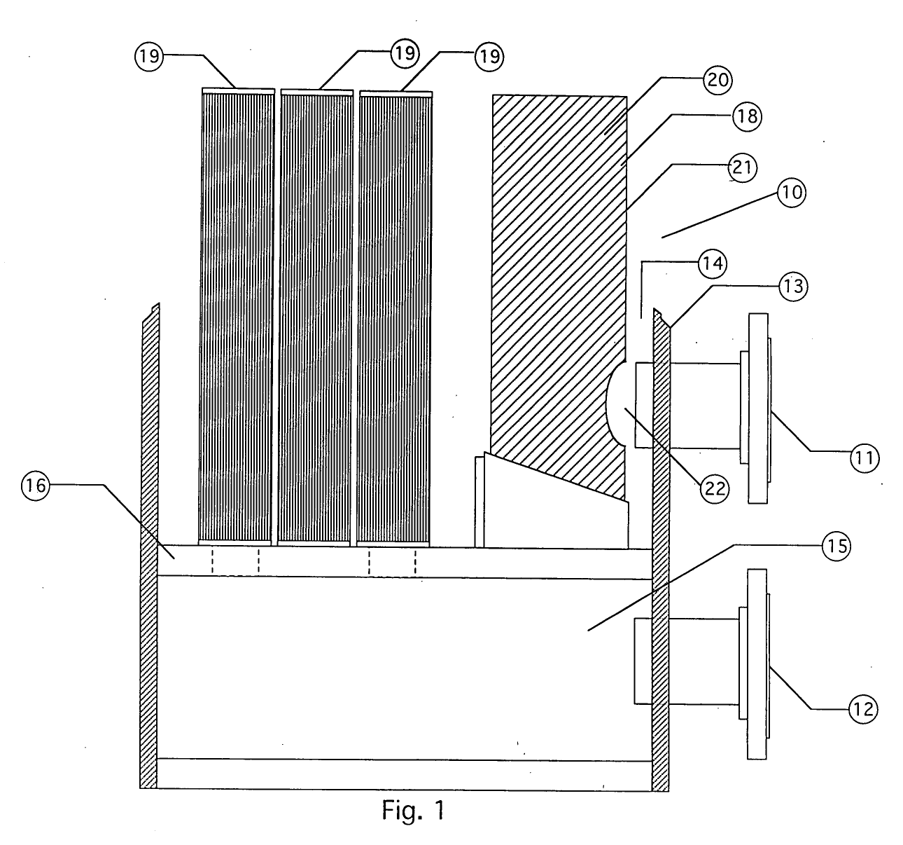

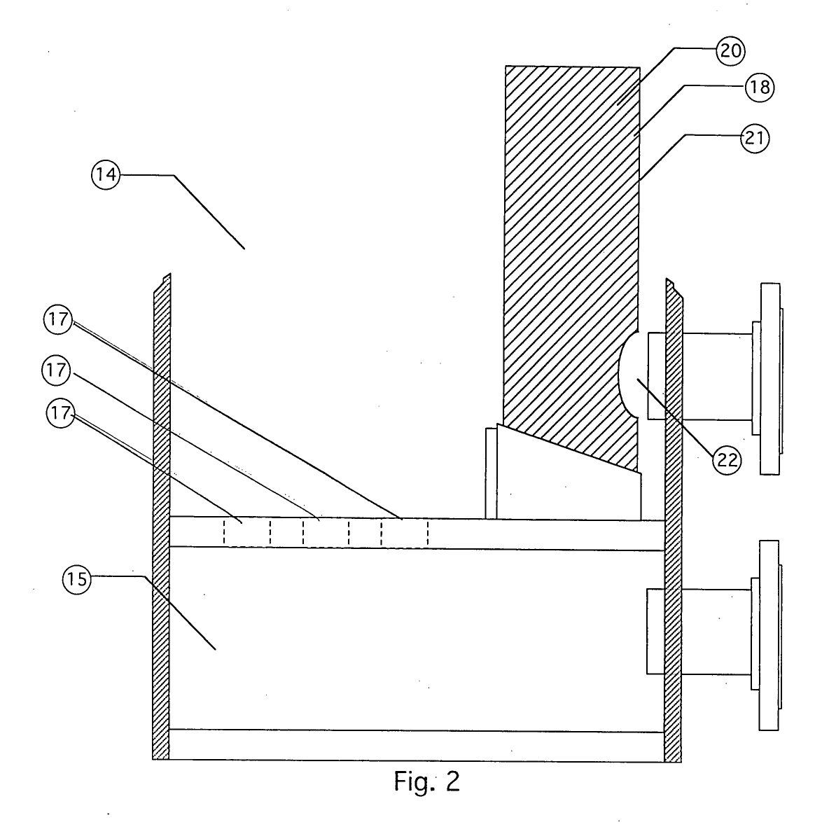

Referring now to FIG. 1, there is shown a particulate filter 10 configured in accordance with the principles of the present invention, wherein the particulate filter 10 includes an inlet 11, a discharge 12, and a housing 13. The inner area of the housing 13 is separated into a fluid receiving area 14, and a fluid outlet area 15. The fluid receiving area 14 and the fluid outlet area 15 are separated by a partition heretofore referred to as the dividing plate 16. As illustrated in FIG. 2, the dividing plate 16 of one particular embodiment of the present invention has three offices 17 for communication between the receiving area 14 and the outlet area 15.

The pre-filter 18 or coarse filter is mounted atop the dividing plate 16 in the fluid receiving area 14, adjacent to the inlet 11. The pre-filter 18 has a substantially tubular mesh body. The pre-filter 18 further comprises a pre-filter orifice 22 to allow unrestricted passage of a fluid, particularly oil, into its inner cavity 20 of the pre-filter 18. The mesh lining 21 of the pre-filter 18 further allows the passage of the fluid into the fluid receiving area 14 while retaining larger particles and impurities in the mesh. This process shall be referred to as the first filtration stage.

In operation, the fluid, typically lubrication oil, enters the particulate filter 10 at inlet 11. Upon passing through the particulate filter inlet 11, towards inner cavity of the particulate filter or receiving area 14 the fluid enters the orifice 22 of the pre-filter 18. The orifice 22 of the pre-filter 18 is positioned an adequate distance from the inlet 11 of the particulate filter 10, wherein the fluid passing through the inlet 11 of the particulate filter 10 flows directly through the orifice 22 of the pre-filter 18 into the inner cavity 20 of the pre-filter 18. During the first filtration stage the fluid passes through the inner cavity 20 of the pre-filter 18, while the mesh lining 21 of the pre-filter 18 retains larger particles and impurities.

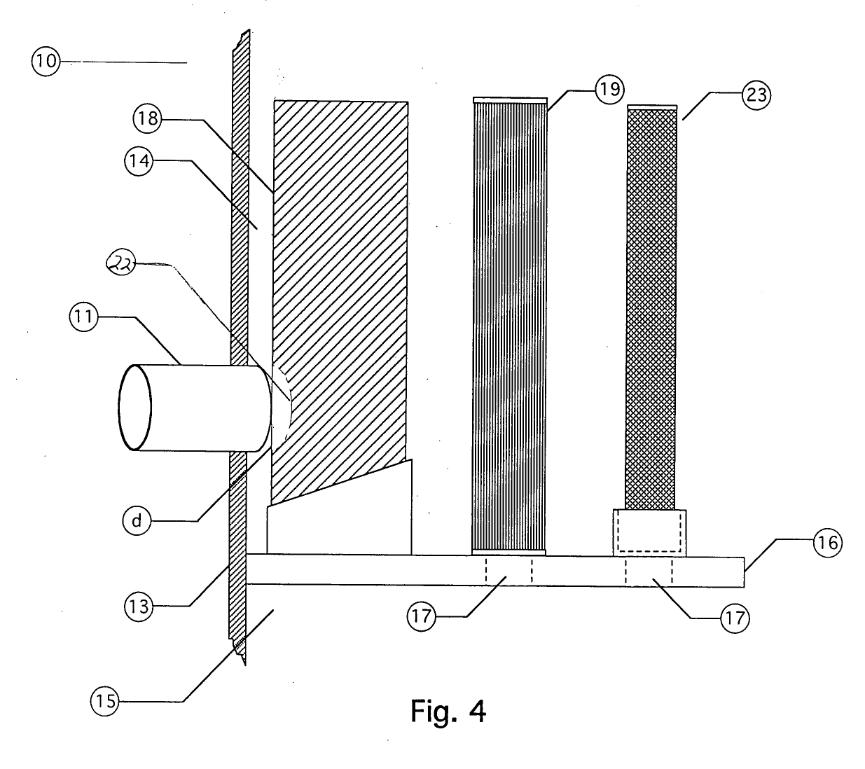

As better illustrated in FIG. 4, the orifice 22 of the pre-filter 18 is spaced a distance from the inlet 11. Although a specific orifice 22 shape is illustrated in the drawings other shapes are contemplated. This distance shall allow the fluid flowing through the inlet 11 to enter the fluid receiving area 14 directly when the pre-filter 18 becomes clogged, thereby bypassing the pre-filter 18. As particles accumulate on the inner mesh lining 21 of the pre-filter 18, flow from the inlet 11 into the pre-filter 18 becomes restricted. When a sufficient amount of particles are retained within the inner mesh lining 21 of the pre-filter 18 so that the filter becomes blocked, flow into the pre-filter is halted. However, flow from the inlet 11 directly into the fluid receiving area 14, and through the fine filters 19 continues. At this time the filtration process is served solely by the fine filters 19, until the pre-filter could be serviced. This apparatus reduces down time and maintenance, by allowing the filtration process to continue in the event the first filtration stage becomes blocked.

As illustrated in FIG. 4, an additional embodiment of the present invention is contemplated wherein third stage strainers 23 are included to further protect the system. The third stage strainers 23 protect the fine elements 19 from element failure or back pulses in the system. The third stage elements 23 shall typically be mounted above the orifice 17, and on the dividing plate 16. Furthermore, in this particular embodiment, the fine filters 19 are mounted above the third stage filters 23.

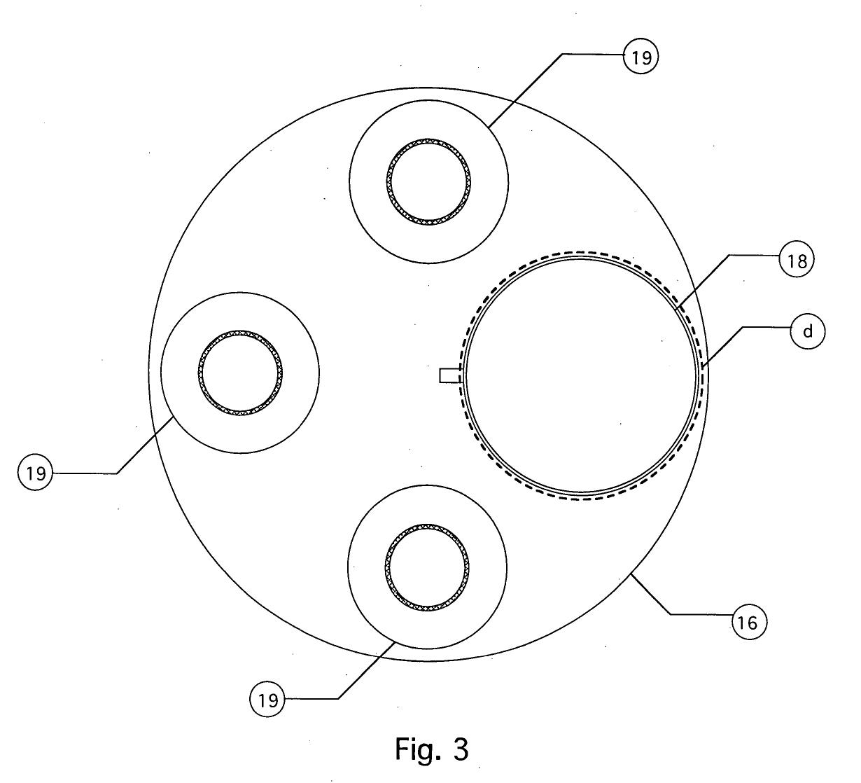

Referring now to FIGS. 1 and 3, mounted in the fluid receiving area 14, atop each orifice 17 on the dividing plate 16 is one or more filter elements or fine filters 19. These fine filters 19 receive the fluid that has passed through the first filtration stage, removing finer particles and impurities before allowing the fluid to pass into the outlet area 15, and ultimately exiting the particulate filter 10 through the discharge 12. While the drawings illustrate a device with three fine filters 19, alternate designs with one or more fine filters are contemplated.

While this invention has been described as having a preferred design, the present invention can be further modified within the spirit and scope of this disclosure. This application is therefore intended to cover any variations, uses, or adaptations of the present invention using the general principles disclosed herein. Further, this application is intended to cover such departures from the present disclosure as come within the known or customary practice in the art to which this invention pertains and which fall within the limits of the appended claims.

I claim:

1. A filter assembly for collecting particles incorporated in a liquid, comprising: a pre-filter for retaining coarse particles and allowing flow of a liquid; at least one secondary filter element of a finer porosity than said pre-filter for receiving said liquid from said pre-filter and further removing particles from said liquid; and said pre-filter is positioned within said filter assembly to allow continuing flow of said liquid to said secondary filter element upon a failure of said pre-filter while said liquid remains internal to said filter assembly.

2. The filter assembly of claim 1 wherein said pre-filter further comprises a substantially tubular mesh body for structural support and the filtration of particles and impurities.

3. The filter assembly of claim 1 wherein said pre-filter further comprises an orifice for receiving said liquid.

4. The filter assembly of claim 1 further comprising a housing, said housing further comprises an inlet port for receiving said liquid, a body section for holding said pre-filter and said secondary filter and an outlet port for discharging said fluid.

5. The filter assembly of claim 4 further comprising a third stage filter between said secondary filter and said outlet port.

6. The filter assembly of claim 4, wherein said body section further contains a plate, said plate having an upper surface and a lower surface, wherein said pre-filter and said secondary filter are mounted upon said upper surface of said plate, and said plate partitions said body section into a receiving region and a outlet region.

7. A filter assembly for collecting particulate material incorporated in a liquid, comprising: a housing having an inlet port, an outlet port, and a body section; said body section further comprises a receiving region and a outlet region separated by a plate; said plate comprises at least one orifice for communication between said receiving region and said outlet region: said plate further comprises at least one particulate pre-filter element for retaining solids and allowing flow of a liquid, said pre-filter further comprising an orifice for receiving said liquid and mounted on said plate in said receiving region of said body section, wherein said orifice of said pre-filter is spaced a distance from said inlet port; at least one secondary particulate filter element of a finer porosity mounted thereto and above said orifice and in said receiving region of said body section.

8. The filter assembly of claim 7 further comprising a third stage filter between said secondary filter element and said outlet port.

9. The filter assembly of claim 7 wherein said distance between said inlet port and said orifice of said pre-filter allows for unrestricted flow of said liquid entering said filter assembly at said inlet port into said orifice of said pre-filter.

10. The filter assembly of claim 9 wherein said distance between said inlet port and said orifice of said pre-filter will allow continuing flow, internal to said filter assembly, of said liquid to said secondary filter element upon a failure of said pre-filter.

11. The filter assembly of claim 10 wherein said pre-filter is removable and cleanable mesh for structural support and the retention of large particles and impurities.

12. The filter assembly of claim 7 wherein said pre-filter comprises a substantially tubular mesh body for structural support and the retention of particles and impurities.

13. The filter assembly of claim 7 further comprising two or more secondary filter elements with a finer porosity than said pre-filter.

14. The filter assembly of claim 7 further comprising three secondary filter elements.

15. A multi stage particulate filter with bypass capabilities internal to said particulate filter comprising: a first stage filter element and a second stage filter element; said first stage filter element configured for filtering coarse materials; said second stage filter element configured for filtering out fine materials; said first stage filter element further configured to allow for continued second stage filtering when said first stage filter element becomes clogged.

16. The multi stage particulate filter of claim 15 wherein said first stage particulate filter element further comprises an orifice for a receiving a liquid, whereupon said clogging of said first stage filter element, said liquid will be restricted from entering said orifice of said first stage filter element, and said liquid shall flow directly to said second stage filter element while remaining internal to said particulate filter.

17. The multi stage particulate filter of claim 15 wherein said first stage filter element further comprises a substantially tubular mesh body for structural support and the filtration of particles and impurities.

18. The multi stage particulate filter of claim 15 wherein said second stage filter element further comprises three second stage filter elements.

19. The multi stage particulate filter of claim 16 further comprising a coalescing filter input port, wherein said orifice of said first stage filtering element is spaced a distance from said particulate filter input port.

20. A multi stage particulate filter with bypass capabilities comprising: a first stage and a second stage; said first stage configured for filtering coarse materials and allowing for continued flow to said second stage upon clogging of first stage; and said second stage configured for filtering out fine materials.
